(19) United States
(12) Patent Application Publication
(10) Pub. No.: US 2008/0155913 A1
(43) Pub. Date: Jul. 3, 2008

(54) WINDOW GRILLE CLIP AND ASSOCIATED WINDOW ASSEMBLY FOR SECTIONAL OVERHEAD DOOR PANELS

(75) Inventor: Brian M. Magill, Cincinnati, OH (US)

Correspondence Address: WOOD, HERRON & EVANS, LLP, 2700 CAREW TOWER, 441 VINE STREET, CINCINNATI, OH, 45202, US

(73) Assignee: CLOPAY BUILDING PRODUCTS R&D COMPANY, INC., Mason, OH (US)

(21) Appl. No.: 11/619,005

(22) Filed: Jan. 2, 2007

(51) Int. Cl. E06B 3/68; E06B 3/48; E05D 15/16; E04G 21/14

(52) U.S. Cl. 52/204.61; 160/206; 52/456; 52/747.1

(57) ABSTRACT

A sectional overhead door includes a window and associated grille and clip for mounting on the panel of the door. The window is mounted by a frame on both the front face and back face of the sectional door panel. The window grille is mounted to the front of the door panel and couples to the frame members on the front face of the panel. The underside of the grille is juxtaposed to the window or glazing element in the frame. The rear face of the grille includes a groove and the lateral sides of each grille member include a pair of rails or channels. A uniquely designed clip fits within the groove and channels. A forwardly projecting tang extends from the central body portion of the clip and is adapted to project into a hole or opening in the window frame when the clip slides relative to the grille member. Another aspect of this invention is that selected terminal ends of the grille members are similarly configured to include tabs that seat within notches in the window frame. The end of at least one of those grille members includes an enlarged tab that seats within an enlarged notch in one of the frame members of the window. This provides for a unique orientation of the grille for installation into the window frame of the overhead door panel.

### BACKGROUND OF THE INVENTION

This invention relates to sectional doors. More specifically, this invention relates to sectional overhead doors that replicate wood sectional carriage house garage doors.

A typical overhead garage door is constructed from a series of door panels, which are hinged together and supported from a track system with rollers attached to opposite ends of the door panels. The rollers allow the door to be moved from a vertically-oriented closed position to a substantially horizontal open position. Electrically powered garage door openers are often used with the overhead garage door so that a user may conveniently open and close the door with ease.

In most residential applications, an overhead garage door is generally either eight or sixteen feet wide. Typically, such a door includes four horizontally oriented door panels, each of which is about eight or sixteen feet wide and twenty-one inches high. For example, a single car residential garage may have an eight foot wide by seven foot high door. Likewise, a two car residential garage may have a single sixteen foot wide door by seven foot high door or two eight foot wide by seven foot high doors.

To increase the aesthetic appeal of overhead garage doors, the panels typically incorporate designs on their front surfaces to complement the architectural details of the house or building. The designs may be selected from a manufacturer's standard collection or may be customized according to the taste and style of the particular buyer. Oftentimes at least one of the panels of the door incorporates windows to further increase visual appeal and to allow for light and visibility within the garage. The windows are constructed from glass or clear acrylic and may be square, rectangular, or arched. Overhead garage doors that incorporate stylish designs and small upper windows are typically referred to as carriage-style garage doors because of their resemblance to swing-out doors.

Carriage-style garage doors are desirable to many home owners because of the character they add to a residence. This is especially true in planned communities, where a unique garage door is a small change that makes a big difference in terms of appearance. As such, manufacturers are constantly searching for ways to make the construction of carriage-style doors easier without compromising their distinctive, customized look. The doors must also be constructed in such a manner to reduce the amount of work and effort associated with installing and maintaining the doors.

For example, the windows in a carriage-style overhead garage door often include grilles within the windows so that the windows each have a multi-paned look. Installing the grilles properly to the window frames can be a time-consuming and tedious task. Moreover, if the window pane ever needs to be replaced, the grille must be removed from the door and reinstalled when the window pane is replaced. An overhead door assembly that incorporates an easily-installed window grille is therefore highly desirable.

### SUMMARY OF THE INVENTION

The various embodiments of this invention offer these and other advantages over known overhead door and panel designs. In one embodiment, this invention includes a number of horizontally-oriented panels vertically stacked one upon the other in edge-to-edge relationship.

The panels are coupled to a track assembly mounted proximate the garage, warehouse or other opening. The track assembly includes a generally vertical section, a generally horizontal section and a curved transition section joining the horizontal and vertical sections together. Rollers are mounted on the panels and coupled to the track assembly to guide the door between a generally vertical closed configuration with the upper and lower edges of the adjacent panels mated together and a generally horizontal open configuration extending generally parallel to the ceiling of the garage or the like.

One aspect of this invention includes a door panel having a window grille and clip for mounting on the window of a multi-panel sectional overhead door. The window frame on the sectional door panel is typically rectangular or square, but may be of other configurations such as oval, diamond, or any other desired shape. The grille includes intersecting, often vertical and horizontal members in a cross or cruciform configuration. Naturally, other shaped window openings and grille configurations can be utilized. The window is mounted by a frame on both the front face and back face of the sectional door panel. The window grille is mounted to the front of the door panel and couples to the frame members on the front face of the panel.

The underside of the grille is juxtaposed to the window or glazing element in the frame. One advantage of this invention is the ability to easily install and remove the grille both during initial assembly of the sectional door and, subsequently, for cleaning or repair. The rear face of the grille includes a groove or channel and the lateral sides of each grille member include a pair of rails or guides. A uniquely designed clip fits within the groove and guides. An elongate central body portion of the clip is seated within the central groove. Outboard wings are seated within the outer lateral rails or guides on the grille member. The outer edge of each wing on the grille clip includes a serrated grip portion, which is exposed along the outboard edges of the grille member for convenient access and manipulation of the clip by a user or installer.

A forwardly projecting tang extends from the central body portion of the clip and is adapted to project into a hole or opening in the window frame when the clip slides relative to the grille member. A pair of barbs project laterally from the central body portion of the clip and are adapted to retain the clip in the groove on the grille member.

Another aspect of this invention is that selected terminal ends of the grille members are similarly configured to include tabs that seat within notches in the window frame. The end of at least one of those grille members includes an enlarged tab that seats within an enlarged notch in one of the frame members of the window. This provides for a unique orientation of the grille for installation into the window frame of the overhead door panel.

### BRIEF DESCRIPTION OF THE DRAWINGS

The objectives and features of the invention will become more readily apparent from the following detailed description taken in conjunction with the accompanying drawings in which:

FIG. 1 is a perspective front view of an overhead sectional door with window grilles according one embodiment of the invention;

FIGS. 2A and 2B are each enlarged views of a window grille being installed in the door of FIG. 1 according to various embodiments of the invention;

FIGS. 3A and 3B are rear perspective views of a clip member being installed in the window grille according to one embodiment of the invention;

FIG. 4 is a bottom elevational view of the clip member of FIG. 3 installed in a window grille according to one embodiment of the invention; and

FIGS. 5A and 5B are sequential cross-sectional views of a window grille and associated clip member being removed from a window according to one embodiment of the invention.

### DETAILED DESCRIPTION OF THE INVENTION

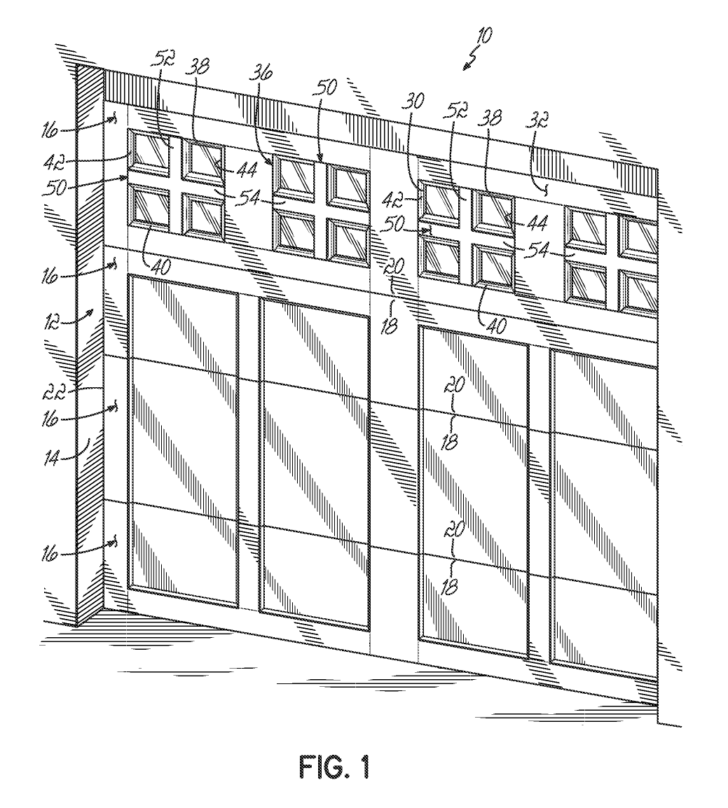

FIG. 1 shows a portion of an overhead door 10 according to one embodiment of the invention. The door 10 is shown in a generally vertical closed position in which it covers an opening 12 in a wall 14 of a garage, warehouse, or the like. In a manner not shown herein, the door 10 may be selectively moved to a generally horizontal open position to expose the interior of the garage.

The door 10 is constructed from a number of serially connected panels 16. To this end, each panel 16 includes upper and lower rails or edges 18, 20, which are generally oriented horizontally and configured to mate with the lower and upper edges respectively, of adjacent panels 16 when the door 10 is in the closed position. One embodiment of the panels is shown in U.S. Pat. No. 6,006,817 which is hereby incorporated by reference in its entirety. The adjacent panels 16 are pivotally connected together by a number of hinges (not shown). Each panel 16 further includes rollers (not shown) mounted proximate to the lateral side ends 22 of each panel 16 to couple the panels to a track assembly (not shown). The track assembly is mounted proximate the door opening 12 and is configured to guide the panels 16 between the open and closed positions. Accordingly, as known in the art, the track assembly includes a generally vertically section, a generally horizontal section, and a transition section joining the horizontal and vertical sections together. The opening and closing of the door 10 may be assisted by a counterbalance system (not shown) coupled to the door 10.

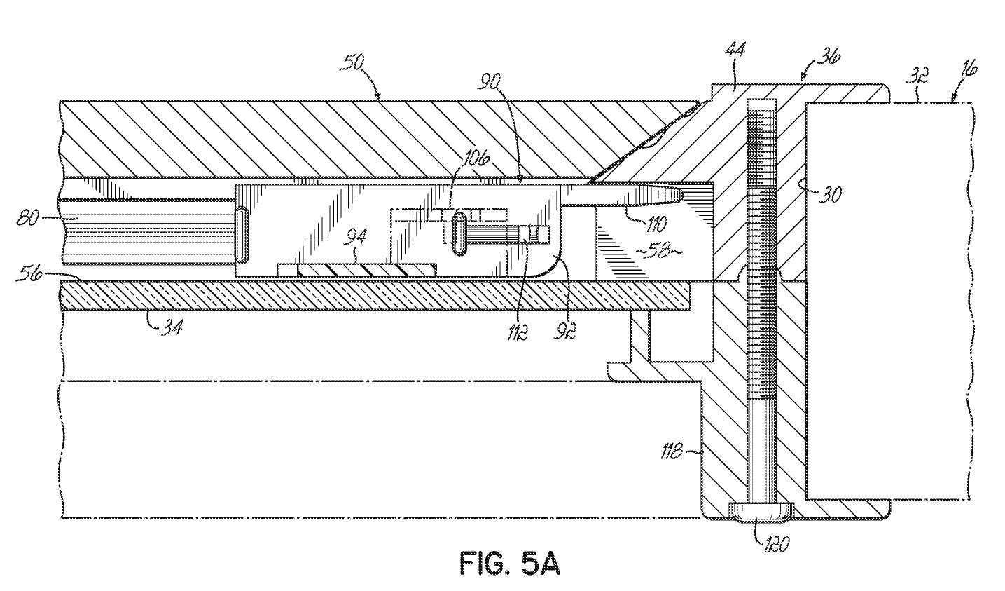

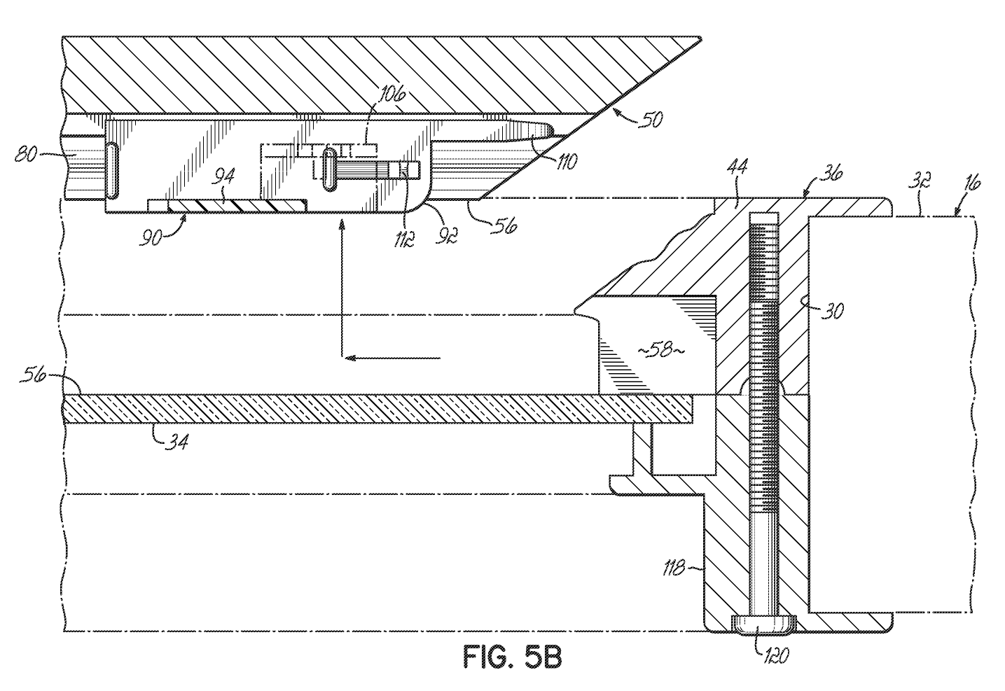

One of the panels 16 defines window openings 30 extending through a front face 32 of the panel 16. A window or glazing element 34 occupies each window opening 30 to provide aesthetic appeal and to close off the openings 30. Each window element 34 is mounted to the panel 16 by a front frame 36 that abuts the front face 32 and extends around the perimeter of the associated window opening 30. A corresponding rear frame 118 (FIGS. 5A and 5B) may be provided on a rear face of the panel 16 to provide additional mounting support and aesthetic appeal. Each frame 36 includes opposed first and second sides 38, 40 and opposed third and fourth sides 42, 44. Although the window openings 30 and frames 36 are shown as having generally square or rectangular configurations, it will be appreciated that a wide variety of other configurations are possible as well. For example, in an alternative embodiment the window openings 30 and frames 36 may have a diamond, circular, or oval-shaped configuration.

The overhead door 10 further includes a grille 50 extending between at least two locations on the window frame 36. In the embodiment shown in the figures, the grille 50 includes a first member 52 extending between the opposed first and second sides 38, 40 and a second member 54 extending between the opposed third and fourth sides 42, 44. The first and second members 52, 54 intersect in a substantially perpendicular manner such that the grille 50 has a cross-shape configuration. As with the window opening 30 and frame 36, it will be appreciated that the grille 50 may be designed to have a wide variety of other configurations.

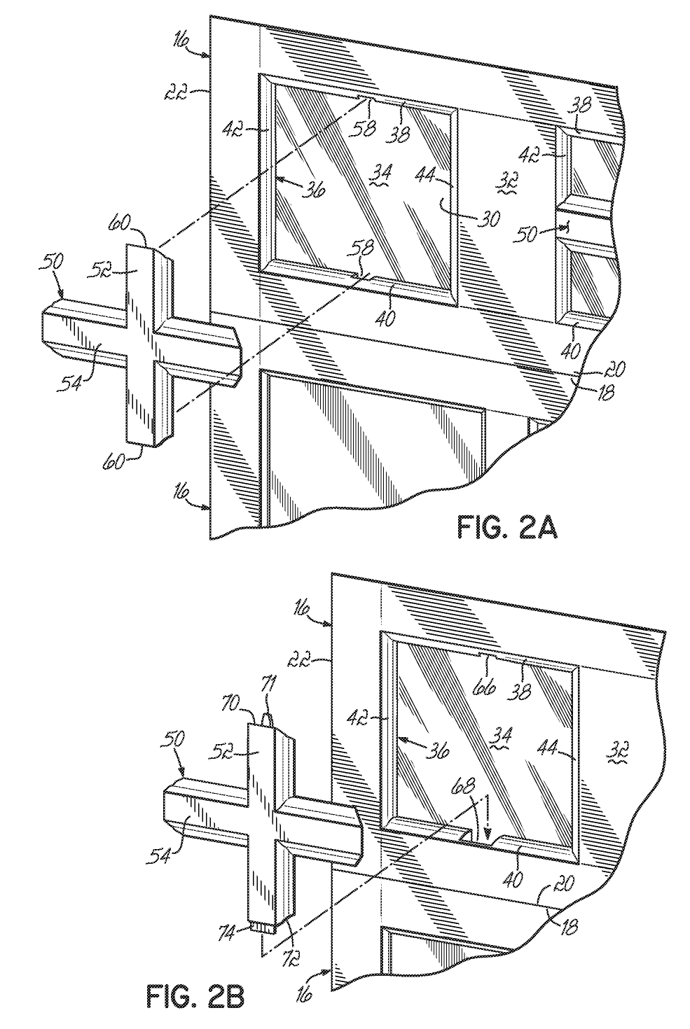

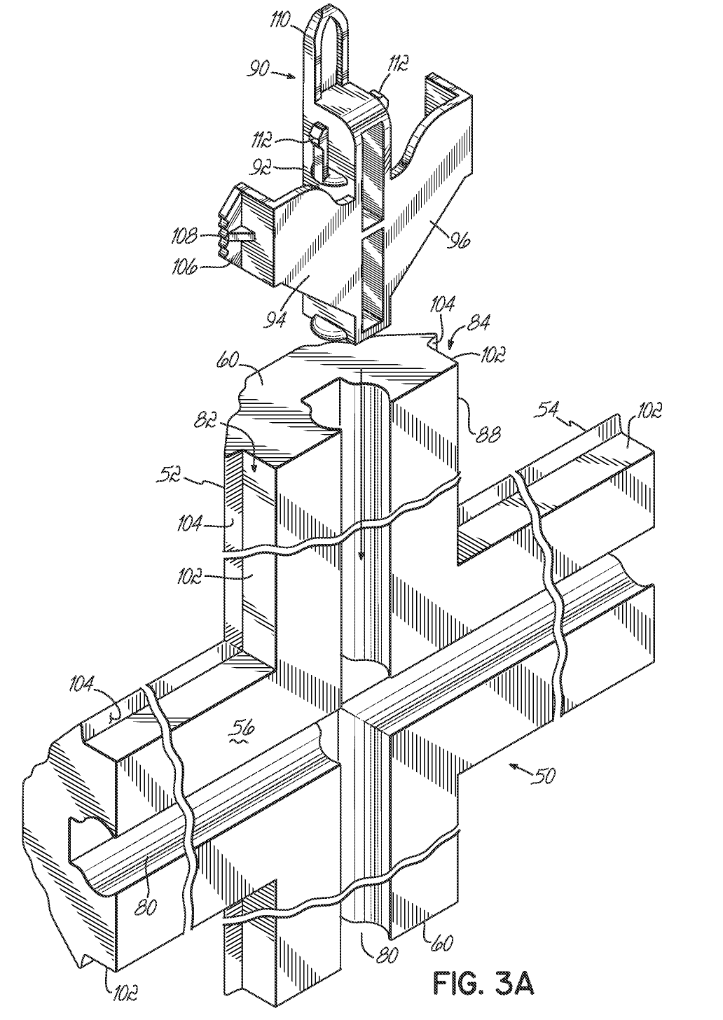

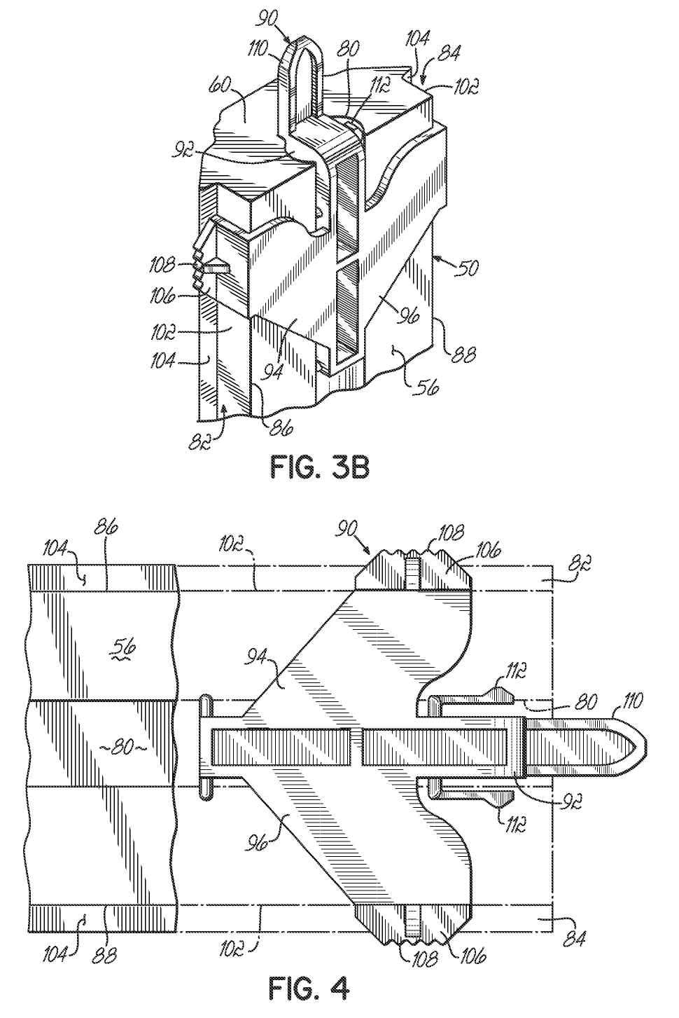

FIGS. 2A and 2B illustrate the grille 50 being installed in one of the window frames 36. The grille 50 is positioned such that a rear face 56 (FIG. 3) is adapted to be juxtaposed to the window element 34. As shown in FIG. 2A, the frame 36 defines one or more openings or notches 58 to be aligned with an associated terminal end 60 on the grille 50. Clip members 90 (FIG. 3) within the grille 50 cooperate with the notches 58 to secure the grille 50 to the frame 36, as will be described below.

In the embodiment shown in FIG. 2B, the frame 36 defines a first notch 66 and second notch 68, with the second notch 68 being larger than the first notch 66. Selected terminal ends of the grille 50 include tabs configured to seat within these notches. More specifically, a first end 70 of the first grille member 52 includes a first tab 71 sized to be received in the first notch 66, while a second end 72 of the first grille member 52 includes a larger, second tab 74 sized to be received by the second notch 68. One or both of the tabs may be defined by a moveable clip member 90 (FIGS. 3A-5B) in the grille 50, as will be described below. Because the second tab 74 is larger than the first notch 66, the grille 50 can only be secured to the frame 36 when the second tab 74 is aligned with the second notch 68. The difference in sizes between the tabs and notches therefore prevents the grille 50 from being installed into the window frame 36 with an incorrect orientation.

With reference to FIGS. 3A and 3B, a portion of the grille 50 is shown in further detail. The grille 50 includes a channel or groove 80 extending along the center of the rear face 56 and first and second lateral guides 82, 84 extending along opposed lateral edges 86, 88 of the rear face 56. The channel 80 is sized to accommodate a clip member 90, which is adapted to slide within the channel 80 and move relative to the grille 50. More specifically, the channel 80 is generally oval-shaped and configured to retain a central body portion 92 of the clip member 90 therein. Such an arrangement permits the clip member 90 to move along the channel 80 without separating from the grille 50. The clip member 90 also includes first and second wing outboard members 94, 96 configured to engage the respective first and second lateral guides 82, 84 to further facilitate movement relative to the grille 50.

As shown in FIGS. 3A, 3B, and 4, the first and second lateral guides 82, 84 are each defined by a lateral side 102 extending upwardly from the rear face 56 and an overhang 104 extending outwardly from the lateral side 102. The first and second wing members 94, 96 each include an outer edge 106 generally proximate to and parallel with the overhang 104. A serrated portion 108 on the outer edge 106 extends beyond the overhang 104 so that the clip member 90 may be easily manipulated by a user, as will be described below.

The clip member 90 further includes a tang 110 extending from the front of the central body portion 92 in a direction generally parallel to the channel 80. The tang 110 is configured to project into and engage one of the notches 58 (FIG. 2A) when the clip member 90 is advanced to the end of the channel 80. Such an arrangement secures the grille 50 to the frame 36 as discussed above with reference to FIGS. 2A and 2B. To prevent the clip member 90 from sliding back within the channel 80, barbs 112 are provided on opposed sides of the central body portion 92. The barbs 112 are preferably designed to create a slight interference fit between the clip member 90 and channel 80 so that the clip member 90 requires some manipulation by a user to move relative to the grille 50. In some embodiments the barbs 112 may extend beyond the channel 80 when the tang 110 is fully advanced into the corresponding notch 58. This allows the barbs 112 to expand laterally such that additional force is required to retract the clip member 90 back along the channel 80.

FIGS. 5A and 5B illustrate the grille 50 being uninstalled from one of the frames 36. As shown in FIG. 5A, in an installed position the rear face 56 of the grille is juxtaposed to the window element 34. The window element 34 is held between the front frame 36 and a rear frame 118, which are coupled together by a fastener or bolt 120. The tang 110 of the clip member 90 is positioned within the notch 58 to secure the grille 50 to the front frame 36. In other words, the tang 110 projects into the notch 58 to prevent the grille 50 from moving away from the window element 34. The grille 50 may include as many clip members 90 as desired. For example, the grille 50 may include a clip member 90 and channel 80 for each portion to be positioned adjacent the window frame 36, or may only include a clip member 90 for one of the portions to be positioned adjacent the frame 36.

To remove the grille 50 from the frame 36, the clip member 90 is pushed back within the channel 80 until the tang 110 is no longer positioned within the notch 58. This may be achieved by an individual gripping the serrated portion 108 of the first and second wing members 94, 96 with his or her thumb and fingers and moving the clip member 90 accordingly. The serrated portions 108 are preferably the only portions of the clip member 90 visible in the installed position. Enough force must be applied by the user to overcome the friction created by the interference fit of the barbs 112.

When the clip member 90 is retracted within the channel 80, the grille 50 may be easily removed from the window element 34 as shown in FIG. 5B. Removing the grille 50 in such a quick and easy manner enables the window elements 34 to be cleaned, replaced, or otherwise maintained with very little effort. The clip member 90 therefore provides a convenient way of installing and uninstalling the window grilles associated with highly desired, carriage-style garage doors.

It should be readily appreciated that although certain embodiments and configurations of the invention are shown and described herein, the invention is not so limited. From the above disclosure of the general principles of the present invention and the preceding detailed description of various embodiments, those skilled in the art will readily comprehend the various modifications to which this invention is susceptible. Therefore, we desire to be limited only by the scope of the following claims and equivalents thereof.

What is claimed is:

1. An overhead door capable of being selectively moved between a generally horizontal open position and a generally vertical closed position covering a door opening, the door comprising:
a plurality of serially connected panels each having a front face, a top rail, and a bottom rail, the top and bottom rails each being adapted to mate with the bottom rail and top rail, respectively, of an adjacent panel, at least one of the panels defining a window opening extending through the front face;
a track assembly mounted proximate the door opening, the track assembly including a generally vertical section, a generally horizontal section, and a transition section joining the horizontal and vertical sections together;
a plurality of rollers mounted on the panels and coupled to the track assembly to guide the door between the closed and open positions;
a plurality of hinge assemblies each mounted to the adjacent panels to pivotally couple the adjacent panels together;
a window element configured to occupy the window opening in the at least one panel;
a frame extending around the window opening and configured to mount the window element to the at least one panel;
a grille extending between a first and second location on the frame, the grille having a rear face adapted to be juxtaposed to the window element and a channel extending along the rear face; and
a clip member moveable within the channel of the grille and adapted to secure the grille to the frame.

2. The overhead door of claim 1, wherein the frame includes opposed first and second sides, the grille extending between the first and second sides.

3. The overhead door of claim 2, wherein the frame further includes opposed third and fourth sides so as to have a rectangular configuration, the grille further comprising:
a first member extending between the opposed first and second sides; and
a second member extending between the opposed third and fourth sides;
wherein the first and second members intersect such that the grille has a cross-shaped configuration.

4. The overhead door of claim 1, wherein the grille further includes first and second lateral guides extending along opposed lateral edges of the rear face, the clip member having a central body portion positioned within the channel of the grille and first and second wings configured to engage the respective first and second lateral guides.

5. The overhead door of claim 4, wherein the first and second lateral guides are each defined by a lateral side extending upwardly from the rear face and an overhang extending outwardly from the lateral side.

6. The overhead door of claim 4, wherein the first and second wings each include an outer edge having a serrated portion extending beyond the corresponding lateral guide to facilitate access and manipulation of the clip member by an individual.

7. The overhead door of claim 4, wherein the frame defines a notch configured to receive a portion of the clip member, the clip member further comprising a tang extending from the central body portion and adapted to project into the notch when the clip member is moved relative to the grille.

8. The overhead door of claim 7, wherein the clip member further includes barbs on opposed sides of the central body portion, the barbs being configured to retain the clip member in the channel of the grille.

9. An overhead door capable of being selectively moved between a generally horizontal open position and a generally vertical closed position covering a door opening, the door comprising:
a plurality of serially connected panels each having a front face, a top rail, and a bottom rail, the top and bottom rails each being adapted to mate with the bottom rail and top rail, respectively, of an adjacent panel, at least one of the panels defining a window opening extending through the front face;
a track assembly mounted proximate the door opening, the track assembly including a generally vertical section, a generally horizontal section, and a transition section joining the horizontal and vertical sections together;
a plurality of rollers mounted on the panels and coupled to the track assembly to guide the door between the closed and open positions;
a plurality of hinge assemblies each mounted to the adjacent panels to pivotally couple the adjacent panels together;
a window element configured to occupy the window opening in the at least one panel;
a frame extending around the window opening and configured to mount the window element to the at least one panel, the frame having a first notch and a second notch, the second notch being larger than the first notch; and
a grille extending between the first notch and second notch in the frame, the grille having a rear face adapted to be juxtaposed to the window element, a first tab adapted to be received in the first notch, and a second tab adapted to be received in the second notch, the first and second tabs cooperating to secure the grille to the frame, the second tab being larger than the first notch to prevent the grille member from being secured to the frame in an incorrect orientation.

10. The overhead door of claim 9, wherein the frame further includes opposed first and second sides and opposed third and fourth sides so as to have a rectangular configuration, the grille further comprising:
a first member extending between the opposed first and second sides; and
a second member extending between the opposed third and fourth sides;
wherein the first and second members intersect such that the grille has a cross-shaped configuration.

11. The overhead door of claim 9, wherein the grille further includes a channel extending along the rear face, the door further comprising:
a first clip member moveable within the channel of the grille and adapted to secure the grille to the frame, the first clip member having a central body portion and a tang extending from the central body portion, the tang defining the first tab.

12. The overhead door of claim 11, further comprising:
a second clip member moveable within the channel of the grille and adapted to secure the grille to the frame, the second clip member having a central body portion and a tang extending from the central body portion, the tang defining the second tab.

13. A method of assembling an overhead door, comprising
providing a plurality of serially connected panels, each panel having a front face, a top rail, and a bottom rail, the top and bottom rails each being adapted to mate with the bottom rail and top rail, respectively, of an adjacent panel, and at least one of the panels defining a window opening extending through the front face;
positioning a window element in the window opening of the at least one panel;
mounting the window element to the at least one panel with a frame extending around the window opening
positioning a grille to extend between a first and second location on the frame, the grille having a rear face adapted to be juxtaposed to the window element and a channel extending along the rear face; and
sliding a clip member within the channel of the grille to engage the frame and thereby secure the grille.

14. The method of claim 13, wherein the sliding the clip member step further comprises:
holding a serrated portion of an outer edge of the clip member;
and moving the clip member relative to the grille.

15. The method of claim 13, wherein the sliding the clip member step further comprises:
moving a central body portion of the clip member along the channel of the grille until a tang extending from the central body portion is positioned within a notch defined by the frame.
